(19) United States
(12) Patent Application Publication
(10) Pub. No.: US 2007/0022175 A1
(43) Pub. Date: Jan. 25, 2007

(54) Computer platform redundant system program remote switching control method and system

(75) Inventors: Ying-Chih Lu, Taipei (TW); Wen-Chian Chao, Taipei (TW)

Correspondence Address: PEARL COHEN ZEDEK, LLP;PEARL COHEN ZEDEK LATZER, LLP, 1500 BROADWAY 12TH FLOOR, NEW YORK, NY, 10036, US

(73) Assignee: Inventec Corporation

(21) Appl. No.: 11/209,737

(22) Filed: Aug. 24, 2005

(30) Foreign Application Priority Data
Jun. 29, 2005 (TW) 094121807

(51) Int. Cl. G06F 15/16

(52) U.S. Cl. 709/217

(57) ABSTRACT

A computer platform redundant system program remote switching control method and system is proposed, which is designed for use with a network system for providing a network-linked computer platform, such as a server, with a redundant system program remote switching control function, and which is characterized by the utilization of a specific network communication protocol for a remote network workstation to send a set of switching control commands in compliant with a specific interface protocol that is utilized on the server for the local server to execute these switching control commands to switch from the main BIOS module to the redundant BIOS module in the event of a failure to the main BIOS module. This feature allows the network management work to be more efficient and responsive than prior art

### BACKGROUND OF THE INVENTION

1. Field of the Invention:

This invention relates to computer network technology, and more particularly, to a computer platform redundant system program remote switching control method and system which is designed for use in conjunction with a network system linked to a computer platform equipped with at least two system program modules, such as a server with a dual BIOS (Basic Input/Output System) architecture including a main BIOS module and a redundant BIOS module, for providing a redundant system program remote switching control capability that allows network management personnel at a remote site to remotely switch the server to operate on the redundant BIOS module in the event of a failure to the redundant BIOS module.

2. Description of Related Art:

A network server is a network-linked computer platform that is permanently linked to a network system, such as the Internet, an intranet system, an extranet system, or a LAN (Local Area Network) system, for providing network-based data services to client workstations that are also linked to the network system.

BIOS (Basic Input/Output System) is a widely used system program on network servers for serving as an interface between the operating system and the various hardware components (including peripheral devices) installed on the server for the purpose of allowing the server to control the operations of these hardware components and peripheral devices through the operating system.

In practical implementation, BIOS programs are typically stored in a non-volatile programmable memory, such as flash memory. In addition, in order to provide backup capability, a server a typically installed with at least two BIOS modules (i.e., the so-called dual BIOS architecture) including a main BIOS module and a redundant BIOS module. The server normally operates on the main BIOS module, and in the event of a failure to the main BIOS module, the server will be promptly switched to operate on the redundant BIOS module, so as to allow the server to continue normal services. In practice, a dual BIOS architecture can be realized by utilizing two separate flash memory modules which are used to store two copies of the same BIOS code respectively, or alternatively by utilizing just one large-capacity flash memory module whose storage space is partitioned into two sections respectively used to store two copies of the same BIOS code.

Presently, there are two methods for a server to switch between main BIOS module and redundant BIOS module: an automatic switching method and a manually-operated jumper-based switching method. The automatic switching method is activated automatically by the server in the event of a failure to the main BIOS module for switching the CPU to operate on the redundant BIOS module; whereas the jumper-based switching method requires the user to manually flip hardware jumpers so as to reconfigure the CPU to operate on the redundant BIOS module in the event of a failure to the main BIOS module. If the automatic switching method fails to switch the server to operate on the redundant BIOS module, however, it nonetheless requires the local network management personnel to employ the jumper-based switching method to manually switch the server to operate on the redundant BIOS module.

In the practice of network management, many enterprise level servers are supervised by network management personnel at remote sites via network workstations linked via a network to the servers. Due to this reason, in the event of a failure to the main BIOS module on a server, the remotely-located network management personnel can be informed of this situation by his/her network workstations linked to the failed server. However, in order to switch the failed server to operate on the redundant BIOS module, the network management personnel nevertheless need to personally contact the local personnel, for example by phone, to ask the local personal to manually switch the failed server to operate on the redundant BIOS module. This practice is undoubtedly quite tedious and time-consuming, making the network management quite inefficient.

### SUMMARY OF THE INVENTION

It is therefore an objective of this invention to provide a computer platform redundant system program remote switching control method and system which allows a remotely located network management person to be able to gain remote access to a failed server and activate the failed server to perform a redundant BIOS switching procedure without requiring local personnel to intervene, so as to make the network management work more efficient and responsive.

The computer platform redundant system program remote switching control method and system according to the invention is designed for use in conjunction with a network system linked to a computer platform equipped with at least two system program modules, such as a server with a dual BIOS (Basic Input/Output System) architecture including a main BIOS module and a redundant BIOS module, for providing a redundant system program remote switching control capability that allows network management personnel at a remote site to remotely switch the server to operate on the redundant BIOS module in the event of a failure to the redundant BIOS module.

The computer platform redundant system program remote switching control method of the invention comprises: (1) on the remote network workstation, generating a user initiated switching request event; (2) on the remote network workstation, responding to the user-initiated switching request event by generating a set of switching control commands in compliant with a specific interface protocol that is utilized on the computer platform; (3) on the remote network workstation, transmitting the switching control commands in data packets compliant with a specific network communication protocol via the network system to the computer platform; (4) on the local computer platform, receiving the data packets transmitted from the local network workstation via the network system and demodulating the data packets to retrieve the original switching control command; (5) on the local computer platform, processing each switching control command to thereby generate a corresponding switching enable message; and (6) on the local computer platform, responding to the switching enable message by performing a switching action on the main system program module and the redundant system program module.

In terms of architecture, the computer platform redundant system program remote switching control system of the invention is based on a distributed architecture comprising: (A) a remote unit; and (B) a local unit; wherein the remote unit is installed on the network workstation, and which includes: (A0) a remote side network communication module, which is capable of linking the network workstation via the network system to the computer platform for the network workstation to communicate with the computer platform via the network system; (A1) a user interface module, which is capable of responding to a user-initiated switching request event by issuing a command transmission enable message; and (A2) a command generating module, which is capable of responding to the command transmission enable message issued by the user interface module by generating a set of switching control commands in compliant with a specific interface protocol that is utilized on the computer platform, and which is capable of transmitting the switching control commands by means of the remote side network communication module and via the network system to the computer platform; and wherein the local unit is installed on the computer platform, and which includes: (B0) a local side network communication module, which is capable of linking the computer platform via the network system to the network workstation for the computer platform to communicate with the network workstation via the network system; (B1) a command processing module, which is capable of processing each switching control command received by the local side network communication module via the network system from the remote unit on the network workstation and thereby output a corresponding switching enable message; and (B2) a switching module, which is capable of responding to the switching enable message from the command processing module by performing a switching action on the main system program module and the redundant system program module.

The computer platform redundant system program remote switching control method and system according to the invention is characterized by the utilization of a specific network communication protocol, such as TCP/IP (Transmission Control Protocol/Internet Protocol) or UD/IP (User Datagram Protocol/Internet Protocol), for a remote network workstation to send a set of switching control commands in compliant with a specific interface protocol that is utilized on the server, such as IPMI (Intelligent Platform Management Interface) compliant commands, for the IPMI-equipped local server to execute these IPMI-compliant switching control commands to switch the CPU to operate on the redundant BIOS module in the event of a failure to the main BIOS module. This feature allows remotely located network management personnel to gain access to the failed server and control the switching of the server from the main BIOS module to the redundant BIOS module without requiring local personnel to intervene, and therefore allows the network management work to be mole efficient and responsive than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and distributed system architecture of the computer platform redundant system program remote switching control system of the invention;

FIG. 2 is a schematic diagram showing the object-oriented component model of the internal architecture of a remote unit utilized by the computer platform redundant system program remote switching control system of the invention; and

FIG. 3 is a schematic diagram showing the object-oriented component model of the internal architecture of a local unit utilized by the computer platform redundant system program remote switching control system of the invention.

### DETAILED DESCRIPTION OF PREFERRED EMBODIMENTS

The computer platform redundant system program remote switching control method and system according to the invention is disclosed in full details by way of preferred embodiments in the following with reference to the accompanying drawings.

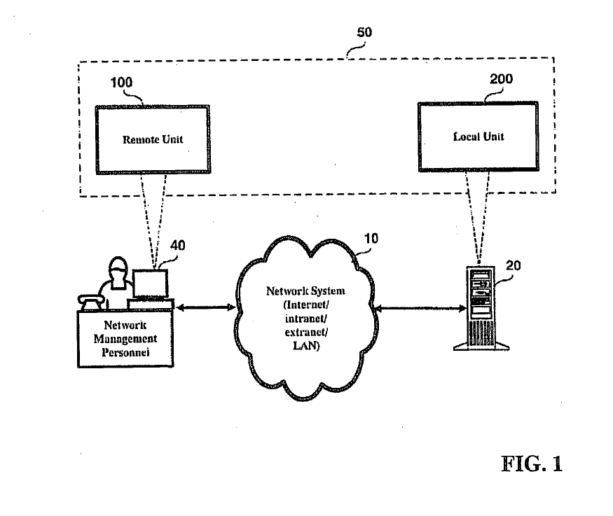

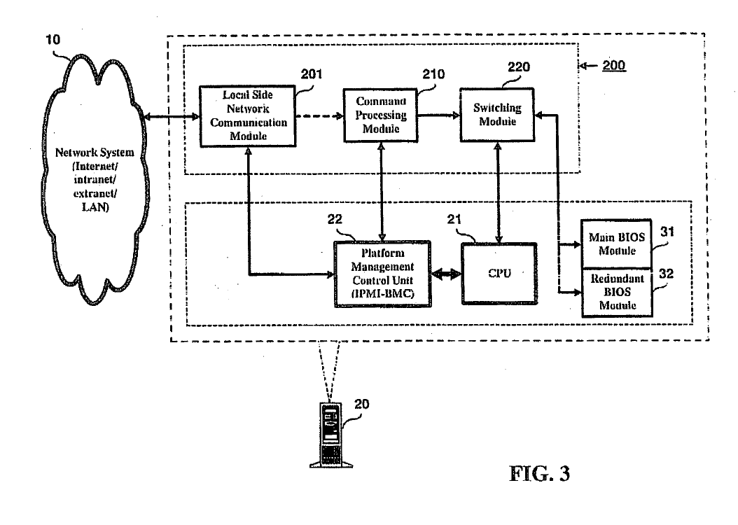

FIG. 1 is a schematic diagram showing the application and distributed system architecture of the computer platform redundant system program remote switching control system according to the invention (as the part enclosed in the dotted box indicated by the reference numeral 50). As shown, the computer platform redundant system program remote switching control system of the invention 50 is designed for use in a distributed manner for installation on a network workstation 40 and a computer platform, such as a network server 20, both of which are linked to a network system 10, such as Internet, an intranet system, an extranet system, a LAN (Local Area Network) system, or a combination thereof. As shown in FIG. 3, the server 20 should be installed with a CPU (Central Processing Unit) 21, a platform management control unit 22, such as a BMC (Baseboard Management Controller) that is based on the standard IPMI (Intelligent Platform Management Interface) protocol, and further installed with at least two system program modules, such as a dual BIOS (Basic Input/Output System) architecture that includes a main BIOS module 31 and a redundant BIOS module 32. In the embodiment of FIG. 1, for example, only one server 20 is illustrated for demonstrative purpose; but in practice, the network workstation 40 can be configured to concurrently perform a redundant system program switching function on two or more servers.

Under normal conditions, the server 20 is configured to operate on the main BIOS module 31 by linking its CPU 21 to the main BIOS module 31 for the CPU 21 to execute the BIOS code in the main BIOS module 31. In the event of a failure to the main BIOS module 31, the computer platform redundant system program remote switching control system of the invention 50 can be employed by remote network management personnel to remotely activate the server 20 to switch the CPU 21 to link to the redundant BIOS module 32 so as to execute the BIOS code stored in the redundant BIOS module 32, whereby the server 20 can be maintained to operate normally despite that the main BIOS module 31 fails.

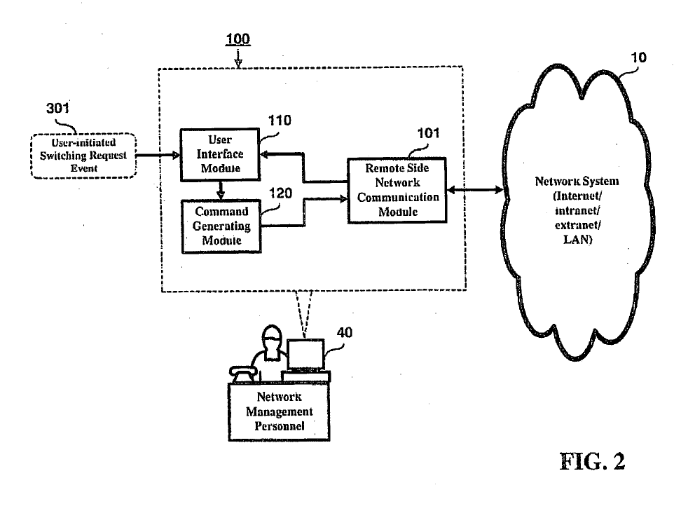

As shown in FIG. 1, in architecture, the computer platform redundant system program remote switching control system of the invention 50 comprises two distributed units: (A) a remote unit 100; and (B) a local unit 200; wherein as shown in FIG. 2, the remote unit 100 is installed on the remote network workstation 40 and whose internal architecture includes: (A0) a remote side network communication module 101; (A1) a user interface module 110; and (A2) a command generating module 120; and wherein, as shown in FIG. 3, the local unit 200 is installed on the server 20 and whose internal architecture includes: (B0) a local side network communication module 201; (B1) a command processing module 710; and (B2) a switching module 220.

Firstly, the respective attributes and functions of the constituent modules 101, 110, 120 of the remote unit 100 are described in details in the following.

The remote side network communication module 101 is installed on the network workstation 40, and which is used for linking the network workstation 40 via the network system 10 to the server 20 for the network workstation 40 to communicate with the server 20 via the network system 10. In practical implementation, for example, this remote side network communication module 101 is based on an NIC (Network Interface Controller) that employs TCP/IP (Transmission Control Protocol/Internet Protocol) or UDP/IP (User Datagram Protocol/Internet Protocol) for network data transmission, and which utilizes the IP (Internet Protocol) address of the server 20 to link via the network system 10 to the server 20.

The user interface module 110 is used for providing a user interface on the network workstation 40 for the user (i e., network management personnel) to operate the remote switching control system of the invention 50. In actual operation, this user interface module 110 is capable of responding to a user-initiated switching request event 301 (i.e., when the user operates his/her network workstation 40 to request the server 20 to switch from the main BIOS module 31 to the redundant BIOS module 32) by issuing a command transmission enable message to the command generating module 120.

The command generating module 120 is capable of responding to the command transmission enable message issued by the user interface module 110 by generating a set of switching control commands in compliant with a specific interface protocol that is utilized on the server 20, and which is capable of transmitting these switching control commands by means of the remote side network communication module 101 and via the network system 10 to the server 20. In the case that the platform management control unit 22 on the server 20 is an IPMI-compliant BMC unit, this command generating module 120 is configured to send the switching control commands in IPMI-compliant formats.

Next, the respective attributes and functions of the constituent modules 201, 210, 220 of the local unit 200 are described in details in the following.

The local side network communication module 201 is installed on the server 20, and which is used for linking the server 20 via the network system 10 to the network workstation 40 for the server 20 to communicate with the network workstation 40 via the network system 10. This local side network communication module 201 should be compliant in network communication protocol with the remote side network communication module 101 installed on the network workstation 40. In practical implementation, for example, the local side network communication module 201 is also based on an NIC unit that employs TCP/IP or UDP/IP network communication protocol, and which utilizes the IP address of the network workstation 40 for linking via the network system 10 to the network workstation 40. In actual operation, this local side network communication module 201 is capable of receiving the TCP/IP or UDP/IP data packets via the network system 10 from the remote unit 100 on the network workstation 40 and demodulate these TCP/IP or UDP/IP data packets to retrieve the IPMI-compliant switching control commands, and then transfer these IPMI-compliant switching control commands via the IPMI-BMC platform management control unit 22 to the command processing module 210.

The command processing module 210 is capable of being controlled by the IPMI-BMC platform management control unit 22 to process each IPMI-compliant switching control command received by the local side network communication module 201 via the network system 10 from the remote unit 100 on the network workstation 40 and thereby output a corresponding switching enable message to the switching module 220.

The switching module 220 is capable of responding to the switching enable message from the command processing module 210 by performing a switching action between the main system program module 31 and the redundant system program module 32, i.e., if the CPU 21 of the server 20 is currently linked to operate on the main BIOS module 31, this switching module 220 will switch the CPU 21 of the server 20 to operate on the redundant BIOS module 32. In practical implementation, for example, this switching module 220 can utilize various methods for switching between the main BIOS module 31 and the redundant BIOS module 32, such as address line switching method, chip select method, to name just a few. Since these switching methods are well-known techniques in computer engineering, detailed description thereof will not be given in this specification.

In the following description of an example of a practical application of the remote switching control system of the invention 50, it is assumed that a failure occurs to the main BIOS module 31 in the server 20 and a system management person is notified of this situation via his/her network workstation 40, and whereupon the system management person wants to utilize the remote switching control system of the invention 50 to switch the serve 20 from the main BIOS module 31 to the redundant BIOS module 32.

Referring to FIG. 1 through FIG. 3 together, in the above-mentioned situation, the system management person needs first to activate the user interface module 110 in the remote unit 100 installed on the network workstation 40, and then initiate a switching request event 301 through the user interface module 110, causing the user interface module 110 to respond by issuing a command transmission enable message to the command generating module 120. In response to this command transmission enable message, the command generating module 120 is activated to generate a set of IPMI-compliant switching control commands, and then activate the remote side network communication module 101 to transmit these IPMI-compliant switching control commands in TCP/IP or UDP/IP compliant data packets for transmission by means of TCP/IP or UDP/IP over the network system 10 to the server 20.

On the local side, the local side network communication module 201 on the server 20 will receive the TCP/IP or UDP/IP data packets transmitted from the network workstation 40 via the network system 10, and then demodulate the TCP/IP or UDP/IP data packets to retrieve the IPMI-compliant switching control commands. The local side network communication module 201 then transfers these IPMI-compliant switching control command to the command processing module 210 which is controlled by the IPMI-BMC platform management control unit 22 to process these IPMI-compliant switching control command and thereby output a corresponding switching enable message to the switching module 220, causing the switching module 220 to respond by performing a switching action that switches the server 20 from the failed main BIOS module 31 to the redundant BIOS module 32. This allows the server 20, in the event of a failure to the main BIOS module 31, to be nevertheless able to sustain its normal operation by executing the BIOS code in the redundant BIOS module 32.

In conclusion, the invention provides a computer platform redundant system program remote switching control method and system which is designed for use with a network system for providing a server with a redundant system program remote switching control function, which is characterized by the utilization of a specific network communication protocol, such as TCP/IP or UDP/IP, for a remote network workstation to send a set of switching control commands in compliant with a specific interface protocol that is utilized on the server, such as IPMI-compliant commands, for the IPMI-equipped server to execute these IPMI-compliant switching control commands to switch the CPU to operate on the redundant BIOS module. This feature allows remotely-located network management personnel to gain access to the failed server and for switching the server to operate on the redundant BIOS module, without requiring local personnel to intervene, and therefore allows the network management work to be more efficient than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform redundant system program remote switching control method for use on a network system linked to a computer platform that is equipped with a main system program module and a redundant system program module for providing the computer platform with a redundant system program remote switching control function that allows a remote network workstation to remotely switch the computer platform to operate between the main system program module and the redundant system program module;
the computer platform redundant system program remote switching control method comprising;
on the remote network workstation, generating a user-initiated switching request event;
on the remote network workstation, responding to the user-initiated switching request event by generating a set of switching control commands in compliant with a specific interface protocol that is utilized on the computer platform;
on the remote network workstation, transmitting the switching control commands in data packets compliant with a specific network communication protocol via the network system to the computer platform;
on the local computer platform, receiving the data packets transmitted from the local network workstation via the network system and demodulating the data packets to retrieve the original switching control command;
on the local computer platform, processing each switching control command to thereby generate a corresponding switching enable message; and
on the local computer platform, responding to the switching enable message by performing a switching action on the main system program module and the redundant system program module.

2. The computer platform redundant system program remote switching control method of claim 1, wherein the computer platform is a network server

3. The computer platform redundant system program remote switching control method of claim 1, wherein the network system includes Internet.

4. The computer platform redundant system program remote switching control method of claim 1, wherein the network system includes an intranet system.

5. The computer platform redundant system program remote switching control method of claim 1, wherein the network system includes an extranet system.

6. The computer platform redundant system program remote switching control method of claim 1, wherein the network system includes an LAN (Local Area Network) system.

7. The computer platform redundant system program remote switching control method of claim 1, wherein the switching control commands are IPMI (Intelligent Platform Management Interface) compliant.

8. The computer platform redundant system program remote switching control method of claim 1, wherein the remote network workstation utilizes TCP/IP (Transmission Control Protocol/Internet Protocol) network communication protocol for transmitting the switching control command to the computer platform.

9. The computer platform redundant system program remote switching control method of claim 1, wherein the remote network workstation utilizes UDP/IP (User Datagram Protocol/Internet Protocol) network communication protocol for transmitting the switching control command to the computer platform.

10. A computer platform redundant system program remote switching control system for use with a network system linked to a computer platform that is equipped with a main system program module and a redundant system program module for providing the computer platform with a redundant system program remote switching control function that allows a remote network workstation to remotely switch the computer platform to operate between the main system program module and the redundant system program module;
the computer platform redundant system program remote switching control system is based on a distributed architecture comprising a remote unit and a local unit; wherein
the remote unit is installed on the network workstation, and which includes:
a remote side network communication module, which is capable of linking the network workstation via the network system to the computer platform for the network workstation to communicate with the computer platform via the network system;
a user interface module, which is capable of responding to a user-initiated switching request event by issuing a command transmission enable message; and
a command generating module, which is capable of responding to the command transmission enable message issued by the user interface module by generating a set of switching control commands in compliant with a specific interface protocol that is utilized on the computer platform, and which is capable of transmitting the switching control commands by means of the remote side network communication module and via the network system to the computer platform; and wherein
the local unit is installed on the computer platform, and which includes:
a local side network communication module, which is capable of linking the computer platform via the network system to the network workstation for the computer platform to communicate with the network workstation via the network system;
a command processing module, which is capable of processing each switching control command received by the local side network communication module via the network system from the remote unit on the network workstation and thereby output a corresponding switching enable message; and
a switching module, which is capable of responding to the switching enable message from the command processing module by performing a switching action on the main system program module and the redundant system program module.

11. The computer platform redundant system program remote switching control system of claim 10, wherein the computer platform is a network server.

12. The computer platform redundant system program remote switching control system of claim 10, wherein the network system includes Internet.

13. The computer platform redundant system program remote switching control system of claim 10, wherein the network system includes an intranet system.

14. The computer platform redundant system program remote switching control system of claim 10, wherein the network system includes an extranet system.

15. The computer platform redundant system program remote switching control system of claim 10, wherein the network system includes an LAN (Local Area Network) system.

16. The computer platform redundant system program remote switching control system of claim 10, wherein the switching control commands generated by the command generating module are IPMI (Intelligent Platform Management Interface) compliant commands.

17. The computer platform redundant system program remote switching control system of claim 10, wherein the remote side network communication module and the local side network communication module communicate with each other via TCP/IP (Transmission Control Protocol/Internet Protocol)

18. The computer platform redundant system program remote switching control system of claim 10, wherein the remote side network communication module and the local side network communication module communicate with each other via UDP/IP (User Datagram Protocol/Internet Protocol).
